(19) United States
(12) Patent Application Publication
(10) Pub. No.: US 2014/0339343 A1
(43) Pub. Date: Nov. 20, 2014

(54) ELECTROSTATIC ATOMIZER

(71) Applicant: PANASONIC CORPORATION, Osaka (JP)

(72) Inventor: Kazuo Nishimura, Osaka (JP)

(73) Assignee: PANASONIC CORPORATION, Osaka (JP)

(21) Appl. No.: 14/368,740

(22) PCT Filed: Nov. 30, 2012
(86) PCT No.: PCT/JP2012/081158

§ 371 Date: Jun. 25, 2014

(30) Foreign Application Priority Data
Jan. 11, 2012 (JP) 2012-003342

(51) Int. Cl. B05B 5/053

(52) U.S. Cl. CPC B05B 5/0533
USPC 239/690

(57) ABSTRACT

An electrostatic atomizer of the present invention includes a pair of thermoelectric elements; a heat absorption-side electrode that electrically connects the pair of thermoelectric elements on heat absorption sides thereof; heat radiation-side electrodes that are electrically connected to the respective thermoelectric elements on heat radiation sides thereof; and a circuit substrate on which a driving circuit configured to control energization of the pair of thermoelectric elements is mounted. The heat absorption-side electrode serves as a discharge electrode, and the heat radiation-side electrodes serve as a heat radiation member. The heat radiation-side electrodes are joined to the circuit substrate so as to be integrated therewith.

### TECHNICAL FIELD

This invention relates to an electrostatic atomizer that generates charged particulate water.

### BACKGROUND ART

An electrostatic atomizer that generates charged particulate water is proposed, for example, in JP 2010-227926A (hereinafter referred to as Document 1). In this electrostatic atomizer, a heat absorption-side electrode that electrically connects a pair of thermoelectric elements on heat absorption sides thereof serves as a discharge electrode, and heat radiation-side electrodes that are connected to the respective thermoelectric elements on heat radiation sides thereof serve as a heat radiation member. Accordingly, downsizing of an electrostatic atomizer can be realized.

In the aforementioned electrostatic atomizer, in order to improve the cooling performance of the heat absorption-side electrode that serves as the discharge electrode, it is conceivable that the heat radiation-side electrodes that serve as the heat radiation member are formed to be large so as to improve the heat radiation performance thereof. However, there is a problem in that, in such a case, the overall apparatus becomes large.

### SUMMARY OF INVENTION

The present invention has been made in view of the above-described problems, and an object of the present invention is to provide an electrostatic atomizer in which improvement of cooling performance of a discharge electrode and downsizing of the overall apparatus are both realized.

In order to solve the above problems, an electrostatic atomizer according to the present invention includes the following configuration.

The present invention is an electrostatic atomizer including a pair of thermoelectric elements; a heat absorption-side electrode that is joined to the thermoelectric elements so as to serve as a discharge electrode, and that electrically connects the pair of thermoelectric elements on heat absorption sides thereof; heat radiation-side electrodes that are electrically connected to the respective thermoelectric elements on heat radiation sides thereof so as to serve as a heat radiation member; and a circuit substrate on which a driving circuit configured to control energization of the pair of thermoelectric elements is mounted. The heat radiation-side electrodes are joined to the circuit substrate so as to be integrated therewith.

It is preferable that the electrostatic atomizer of the present invention includes a counter electrode provided at a position opposing the heat absorption-side electrode, and the counter electrode is joined to the circuit substrate so as to be integrated therewith.

It is preferable that the electrostatic atomizer of the present invention includes a voltage application circuit configured to apply a voltage to the counter electrode, and the voltage application circuit is mounted on the circuit substrate so as to be integrated therewith.

It is preferable that, in the electrostatic atomizer of the present invention, the counter electrode is formed as a conductive pattern on the circuit substrate.

It is preferable that, in the electrostatic atomizer of the present invention, the circuit substrate includes a through-hole that passes therethrough in the thickness direction, and the thermoelectric elements are arranged in the through-hole.

It is preferable that, in the electrostatic atomizer of the present invention, an elastic member is interposed between the heat radiation-side electrodes and the circuit substrate.

It is preferable that, in the electrostatic atomizer of the present invention, the heat absorption-side electrode includes an elastically deformable spring structure.

It is preferable that, in the electrostatic atomizer of the present invention, a porous member serving as a drain passage for excess dew condensation water is arranged on the heat radiation-side electrodes.

It is preferable that, in the electrostatic atomizer of the present invention, the counter electrode and the conductive pattern are connected.

The present invention has an effect in which improvement of cooling performance of a discharge electrode and downsizing of the overall apparatus are both realized.

### BRIEF DESCRIPTION OF DRAWINGS

FIG. 1A illustrates a cross section of an electrostatic atomizer of Embodiment 1 of the present invention;

FIG. 1B illustrates one example of a conductive pattern in the electrostatic atomizer of Embodiment 1 of the present invention;

FIG. 1C illustrates a schematic diagram of a circuit in the electrostatic atomizer of Embodiment 1 of the present invention;

FIG. 2 is a cross section of an electrostatic atomizer of Embodiment 2 of the present invention;

FIG. 3 is a cross section of an electrostatic atomizer of Embodiment 3 of the present invention;

FIG. 4 is a main portion cross section of an electrostatic atomizer of Embodiment 4 of the present invention; and

FIG. 5 is a cross section of an electrostatic atomizer of Embodiment 5 of the present invention.

### DESCRIPTION OF EMBODIMENTS

The present invention will be described with reference to embodiments illustrated in the attached diagrams.

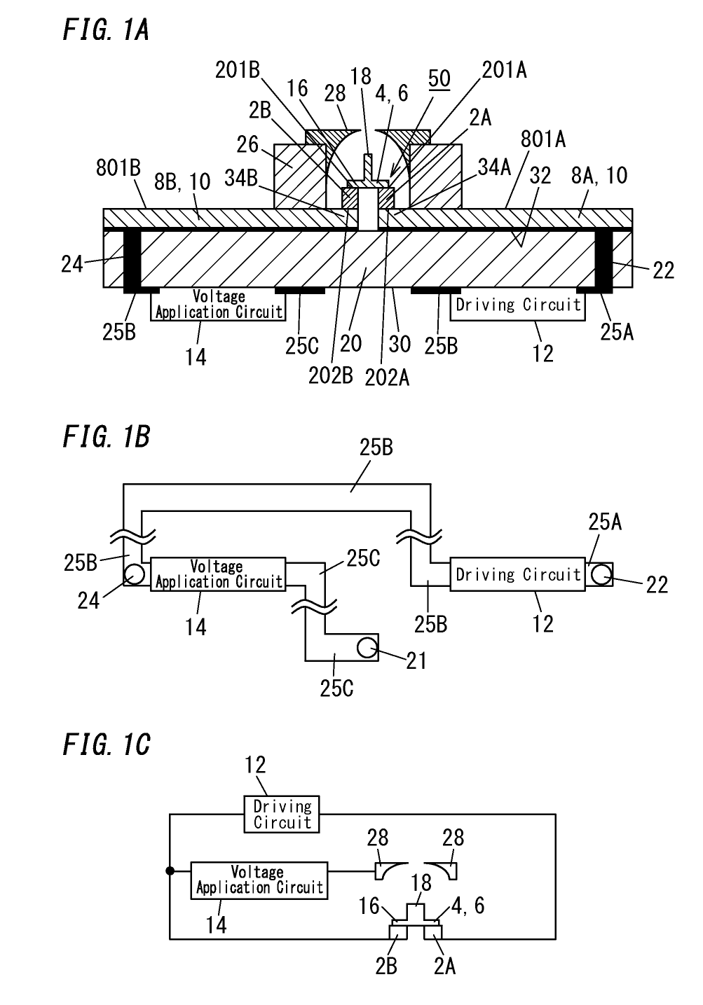

In FIG. 1A, a cross section of an electrostatic atomizer of Embodiment 1 of the present invention is exemplified.

In the electrostatic atomizer of the present embodiment, a pair of thermoelectric elements 2A and 2B that are constituted by P-type and N-type Peltier elements, respectively, are used as a heat exchanger to cool a discharge electrode 6. By energizing the pair of thermoelectric elements 2A and 2B, one end side of each of the thermoelectric elements 2A and 2B (first end 201A and 201B) (upperside in the diagram) becomes a heat absorption side, and the other end side (second ends 202A and 202B of the pair of the thermoelectric element 2A and 2B) (lowerside in the diagram) becomes a heat radiation side.

A heat absorption-side electrode 4 that serves as a discharge electrode 6 for electrostatic atomization is joined to heat absorption-side end faces 201A and 201B of the pair of thermoelectric elements 2A and 2B via a solder which is not illustrated.

In other words, the electrostatic atomizer of the present embodiment includes the pair of the first thermoelectric element 2A and the second thermoelectric element 2B, and the first thermoelectric element 2A and the second thermoelectric element 2B have the respective first ends 201A and 201B on the heat absorption sides thereof. The heat absorption-side electrode 4 is joined to the first ends 201A and 201B, and the heat absorption-side electrode 4 is configured to serve as the discharge electrode 6 for electrostatic atomization. In this case, it is preferable that the first ends 201A and 201B are joined to the heat absorption-side electrode 4 via solder.

The aforementioned heat absorption-side electrode 4 is constituted by a base portion 16 and a bar-shaped portion 18 that is integrally formed therewith and protruding from a center portion thereof. That is, in the heat absorption-side electrode 4, the base portion 16 and the bar-shaped portion 18 are formed integrally, and the bar-shaped portion 18 protrudes from the center portion of the base portion 16 in the vertical direction toward a counter electrode 28.

Also, a flat plate-shaped heat radiation-side electrode 8 is joined to each of heat radiation-side end faces of the pair of thermoelectric elements 2A and 2B (second ends 202A and 202B of the pair of thermoelectric elements 2) via solder which is not illustrated.

In other words, the electrostatic atomizer of the present embodiment includes the pair of the first thermoelectric element 2A and the second thermoelectric element 2B, and the first thermoelectric element 2A and the second thermoelectric element 2B have the respective second ends 202A and 202B on the heat radiation sides thereof. The second ends 202A and 202B are joined to a first heat radiation-side electrode 8A and a second heat radiation-side electrode 8B, respectively. Here, the first heat radiation-side electrode 8A and the second heat radiation-side electrode 8B are configured as a pair, and each shaped like a flat plate. In this case, it is preferable that the first heat radiation-side electrode 8A and the second heat radiation-side electrode 8B are joined via solder to the second end 202A of the first thermoelectric element 2A and the second end 202B of the second thermoelectric element 2B, respectively.

The aforementioned heat radiation-side electrodes 8 are formed by a metal having superior electrical conductivity and thermal conductivity such as brass, aluminum, and copper.

These heat radiation-side electrodes 8 are electrically connected to a driving circuit 12 that is mounted on a circuit substrate 20, via a first connection portion 22 such as a through-hole that passes through the circuit substrate 20 in the thickness direction.

In other words, the circuit substrate 20 includes a first face 30 and a second face 32. It is preferable that the first connection portion 22 that passes through the circuit substrate 20 in the thickness direction is formed such that the driving circuit 12 mounted on the first face 30 of the circuit substrate 20 is electrically connected to the first heat radiation-side electrode 8A. In this case, the first connection portion 22 is exemplified by a through-hole or the like.

The pair of thermoelectric elements 2A and 2B are energized by such a driving circuit 12 and heat radiation-side electrodes 8. In other words, the pair of the first thermoelectric element 2A and the second thermoelectric element 2B are energized by the driving circuit 12 and the heat radiation-side electrodes 8.

In addition, these flat plate-shaped heat radiation-side electrodes 8A and 8B are constituted by the first heat radiation-side electrode 8A and the second heat radiation-side electrode 8B. Here, the first heat radiation-side electrode 8A has a first heat radiation face 801A that is joined to the second end 202A of the first thermoelectric element 2A, and the second heat radiation-side electrode 8B has a second heat radiation face 801B that is joined to the second end 202B of the second thermoelectric element 2B. In this case, heat is radiated from the outer surfaces of the heat radiation-side electrodes 8A and 8B (the first heat radiation face 801A of the first heat radiation-side electrode 8A and the second heat radiation face 801B of the second heat radiation-side electrode 8B) highly efficiently. That is, the heat radiation-side electrodes 8A and 8B themselves serve as a heat radiation member 10 for a heat exchanger.

A casing 26 is joined to the outer surfaces of the pair of heat radiation-side electrodes 8A and 8B (the first heat radiation face 801A of the first heat radiation-side electrode 8A and the second heat radiation face 801B of the second heat radiation-side electrode 8B) so as to bridge the first heat radiation-side electrode 8A and the second heat radiation-side electrode 8B. The casing 26 is an insulating cylindrical member formed by a resin such as PBT, PPS, polycarbonate, and a liquid crystal polymer, and is provided so as to radiate heat from the heat radiation-side electrodes 8A and 8B via the casing 26 as well.

The casing 26 houses the pair of thermoelectric elements 2A and 2B and the heat absorption-side electrode 4 that serves as the discharge electrode 6. Also, a ring-shaped counter electrode 28 is provided at a position in the casing 26 such that the ring-shaped counter electrode 28 opposes the tip of the bar-shaped portion 18 of the heat absorption-side electrode 4. In this case, it is preferable that the counter electrode 28 is supported by the casing 26. As an example, the counter electrode 28 is formed in a ring shape using a metal such as SUS, copper, or platinum, or a conductive resin. Further, the counter electrode 28 and the casing 26 may be joined by an adhesive(s) or a screw(s), or the counter electrode 28 may be heat sealed to the casing 26 made of resin.

The counter electrode 28 is electrically connected to a voltage application circuit 14 that is mounted on the first face 30 of the circuit substrate 20 via a second connection portion 24 such as a through-hole that passes through the circuit substrate 20 in the thickness direction. A high voltage for electrostatic atomization is applied to the counter electrode 28 by this voltage application circuit 14.

Specifically, the electrostatic atomizer of the present embodiment includes a first conductive pattern 25A, a second conductive pattern 25B, and a third conductive pattern 25C on the first face 30 of the circuit substrate 20. Here, the first conductive pattern 25A includes the first connection portion 22, the second conductive pattern 25B includes the second connection portion 24, and the third conductive pattern 25C includes a third connection portion 21. The third connection portion 21 is provided so as to pass through at least the circuit substrate 20 and the first heat radiation-side electrode 8A or the second heat radiation-side electrode 8B in the thickness direction of the circuit substrate 20, and is configured to be connected to the counter electrode 28. In this case, the third connection portion 21 is a through-hole or the like, and such a third connection portion 21 may be formed so as to be at least insulated from the first heat radiation-side electrode 8A or the second heat radiation-side electrode 8B in which the through-hole is provided.

Also, the driving circuit 12 and the voltage application circuit 14 are connected by the second conductive pattern 25B via the second connection portion 24. The driving circuit 12 is thereby electrically connected to the heat absorption-side electrode 4, and a circuit of an electrical path is formed via the first connection portion 22 and the second connection portion 24 (refer to FIG. 1B).

The first conductive pattern 25A, the second conductive pattern 25B, and the third conductive pattern 25C are constituted by a conductive member such as a conductive paste, and can be formed by processing such as etching.

In this case, it is preferable that the second conductive pattern 25B and the third conductive pattern 25C are arranged so as not to overlap each other. However, the arrangement is not limited thereto, and even if the second conductive pattern 25B and the third conductive pattern 25C are arranged so as to overlap each other, an insulating film may be provided between the second conductive pattern 25B and the third conductive pattern 25C.

Also, in the electrostatic atomizer of the present embodiment, the flat plate-shaped heat radiation-side electrodes 8 are integrally joined on the second face 32 of the circuit substrate 20 on which the driving circuit 12 and the voltage application circuit 14 are mounted on the first face 30 thereof.

Specifically, as shown in the diagram, the driving circuit 12 and the voltage application circuit 14 are mounted on the first face 30 of the circuit substrate 20 that has the flat first face 30 and the second face 32. Also, the pair of flat plate-shaped heat radiation-side electrodes 8 are stacked on the second face 32 that faces the opposite direction to the direction the first face 30 faces. Edge portions 34 of the pair of heat radiation-side electrodes 8 face each other via a small space on the second face 32.

In other words, regarding the first face 30 and the second face 32 of the circuit substrate 20, the second face 32 is located on the side opposite to the first face 30, and the pair of flat plate-shaped heat radiation-side electrodes 8A and 8B are stacked on the second face 32 side. In this case, the pair of heat radiation-side electrodes 8A and 8B are constituted by the first heat radiation-side electrode 8A and the second heat radiation-side electrode 8B. Also, on the second face 32 side, a small space is provided between a first edge portion 34A of the first heat radiation-side electrode 8A and a second edge portion 34B of the second heat radiation-side electrode 8B. The first edge portion 34A of the first heat radiation-side electrode 8A and the second edge portion 34B of the second heat radiation-side electrode 8B are thereby configured to face each other via the space.

The thermoelectric elements 2A and 2B are provided so as to stand on the edge portion 34A of the heat radiation-side electrode 8A and the edge portion 34B of the heat radiation-side electrode 8B, respectively, and the heat absorption-side electrode 4 that is provided so as to bridge the pair of thermoelectric element 2A and 2B is supported at a position at which the heat absorption-side electrode 4 opposes the second face 32 of the circuit substrate 20. The casing 26 is joined on the heat radiation-side electrodes 8A and 8B so as to surround the thermoelectric elements 2A and 2B and the heat absorption-side electrode 4.

Specifically, the electrostatic atomizer of the present embodiment includes the pair of the first thermoelectric element 2A and the second thermoelectric element 2B, and the first thermoelectric element 2A and the second thermoelectric element 2B are provided on the first edge portion 34A of the first heat radiation-side electrode 8A and the second edge portion 34B of the second heat radiation-side electrode 8B, respectively. Also, the heat absorption-side electrode 4 is provided so as to bridge the first thermoelectric element 2A and the second thermoelectric element 2B, and is supported at a position at which the heat absorption-side electrode 4 opposes the second face 32 of the circuit substrate 20. Further, the casing 26 is provided to be joined to and to bridge the first heat radiation-side electrode 8A and the second heat radiation-side electrode 8B so as to surround the first thermoelectric element 2A, the second thermoelectric element 2B, and the heat absorption-side electrode 4.

In the electrostatic atomizer of the present embodiment including the above configuration, first, the pair of the thermoelectric elements 2A and 2B are energized by the driving circuit 12 in a fixed direction via the pair of heat radiation-side electrodes 8A and 8B and the heat absorption-side electrode 4. Accordingly, the heat absorption-side electrode 4 is directly cooled, and dew condensation water is generated on a surface of the heat absorption-side electrode 4. By applying a predetermined voltage to the counter electrode 28 with the voltage application circuit 14 in the state where the dew condensation water is adhered to the heat absorption-side electrode 4 that serves as the discharge electrode 6, the dew condensation water is electrostatically atomized by the electric field generated at the tip side of the bar-shaped portion 18, and charged particulate water is generated and emitted (refer to FIG. 1C).

In the electrostatic atomizer of the present embodiment, an atomizing block 50 that includes the pair of thermoelectric elements 2A and 2B, the heat absorption-side electrode 4, and the pair of heat radiation-side electrodes 8A and 8B, and the circuit substrate 20 on which the driving circuit 12 and the voltage application circuit 14 are mounted are integrated as described above. Accordingly, the electrostatic atomizer as a whole can be downsized. Also, according to the electrostatic atomizer of the present embodiment, the pair of heat radiation-side electrodes 8A and 8B that serve as a heat radiation member 10 can be provided to be large by making use of the entirety of second face 32 of the circuit substrate 20. Accordingly, heat radiation performance is improved, and the cooling performance of the heat absorption-side electrode 4 that serves as the discharge electrode 6 is improved.

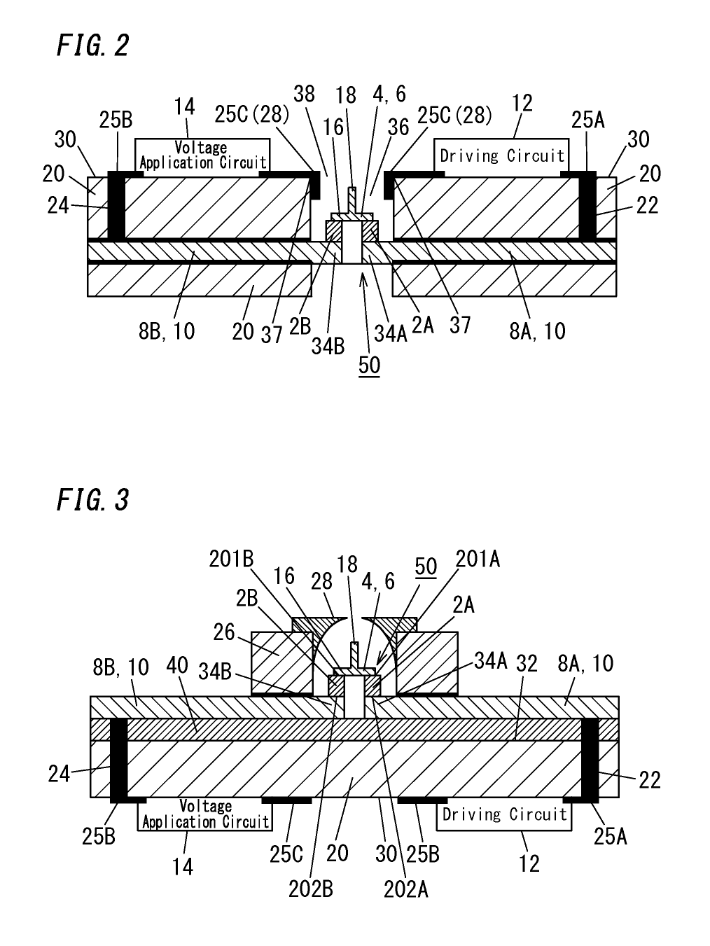

Next, an electrostatic atomizer of Embodiment 2 of the present invention will be described with reference to FIG. 2. Note that constituent elements similar to those in Embodiment 1 described above are provided with the same reference numerals, and detailed description thereof will be omitted.

In the electrostatic atomizer of the present embodiment, a through-hole 36 that passes through a circuit substrate 20 in the thickness direction is formed in a center portion thereof. A pair of heat radiation-side electrodes 8A and 8B are embedded in the circuit substrate 20, and edge portions 34A and 34B of the heat radiation-side electrodes 8A and 8B is exposed inside the through-hole 36.

In other words, in the aforementioned electrostatic atomizer, the through-hole 36 that passes through the circuit substrate 20 in the thickness direction is provided in the center portion thereof. A pair of a first heat radiation-side electrode 8A and a second heat radiation-side electrode 8B is embedded in the circuit substrate 20. A first edge portion 34A of the first heat radiation-side electrode 8A and a second edge portion 34B of the second heat radiation-side electrode 8B are configured to be exposed on the center side of the through-hole 36.

In the through-hole 36, thermoelectric elements 2A and 2B are provided so as to respectively stand on the edge portions 34A and 34B of the pair of heat radiation-side electrodes 8A and 8B, and a heat absorption-side electrode 4 is provided to bridge the pair of the thermoelectric elements 2A and 2B. Also, a counter electrode 28 constituted by a conductive pattern is mounted on an inner circumferential face of the through-hole 36 near an opening 38 at a location opposing the tip of a bar-shaped portion 18 of the heat absorption-side electrode 4 that serves as a discharge electrode 6. A driving circuit 12 and a voltage application circuit 14 are mounted on the flat face of the circuit substrate 20 on the opening 38 side, and are electrically connected to the counter electrode 28 and the heat radiation-side electrodes 8.

In other words, the electrostatic atomizer of the present embodiment includes the pair of the first heat radiation-side electrode 8A and the second heat radiation-side electrode 8B. The first heat radiation-side electrode 8A includes the first edge portion 34A, and the second heat radiation-side electrode 8B includes the second edge portion 34B. Also, a small space is provided between the first edge portion 34A and the second edge portion 34B. The first edge portion 34A of the first heat radiation-side electrode 8A and the second edge portion 34B of the second heat radiation-side electrode 8B are thereby configured to oppose each other via the space. Also, the first edge portion 34A and the second edge portion 34B are provided with the first thermoelectric element 2A and the second thermoelectric element 2B, respectively. The heat absorption-side electrode 4 is provided so as to bridge the first thermoelectric element 2A and the second thermoelectric element 2B. Further, an edge 37 of the through-hole 36 is located at a position opposing the tip of the bar-shaped portion 18 of the heat absorption-side electrode 4 that serves as the discharge electrode 6. On the inner circumferential face of the through-hole 36 and on the first face 30 of the circuit substrate 20 near the edge 37, the counter electrode 28 is mounted along the edge 37. Furthermore, the driving circuit 12 and the voltage application circuit 14 are provided on the first face 30 of the circuit substrate 20, and are electrically connected to the counter electrode 28 and the heat radiation-side electrodes 8.

Here, the electrostatic atomizer of the present embodiment includes a first conductive pattern 25A, a second conductive pattern 25B, and a third conductive pattern 25C on the first face 30 of the circuit substrate 20. The first conductive pattern 25A includes a first connection portion 22, and the second conductive pattern 25B includes a second connection portion 24. Also, the third conductive pattern 25C is connected to the voltage application circuit 14 so as to be the counter electrode 28.

Also, the driving circuit 12 and the voltage application circuit 14 are connected by the second conductive pattern 25B. The driving circuit 12 is thereby electrically connected to the heat absorption-side electrode 4, and a circuit of an electrical path is formed via the first connection portion 22 and the second connection portion 24. Note that the driving circuit 12 is not electrically connected to the third conductive pattern 25C.

The first conductive pattern 25A, the second conductive pattern 25B, and the third conductive pattern 25C are constituted by a conductive material such as a conductive paste, and can be formed by processing such as etching.

In this case, it is preferable that the second conductive pattern 25B and the third conductive pattern 25C are arranged so as not to overlap each other.

In the electrostatic atomizer of the present embodiment as well, similarly to Embodiment 1, the pair of thermoelectric elements 2A and 2B are energized by the driving circuit 12 such that the heat absorption-side electrode 4 is cooled and dew condensation water is adhered to the surface thereof. Here, a predetermined voltage is applied to the counter electrode 28 by the voltage application circuit 14 in order to electrostatically atomize the dew condensation water at the tip of the bar-shaped portion 18, and generated charged particulate water can be emitted outside through the opening 38 of the through-hole 36.

In the electrostatic atomizer of the present embodiment, the pair of thermoelectric elements 2A and 2B and the heat absorption-side electrode 4 are arranged in the through-hole 36 of the circuit substrate 20. Accordingly, even in a case where excess dew condensation water is generated, the excess dew condensation water can be discharged through the through-hole 36, accumulation of water in the circuit substrate 20 can be suppressed, and reliability can be improved. Moreover, since the inner circumferential face of the through-hole 36 surrounds the pair of thermoelectric elements 2A and 2B and the heat absorption-side electrode 4, and can support the counter electrode 28 even if a casing 26 shown in Embodiment 1 is not provided separately, downsizing and cost reduction can be realized. In addition, since the counter electrode 28 is formed as a conductive pattern on the circuit substrate 20, a counter electrode 28 shown in Embodiment 1 need not be attached separately, and the number of components can be reduced.

Next, an electrostatic atomizer of Embodiment 3 of the present invention will be described with reference to FIG. 3. Note that constituent elements similar to those in Embodiment 1 described above are provided with the same reference numerals, and detailed description thereof will be omitted.

In the electrostatic atomizer of the present embodiment, a flat plate-shaped elastic member 40 composed of silicone-based rubber or the like is interposed as a layer between a pair of flat plate-shaped heat radiation-side electrodes 8A and 8B and a likewise flat plate-shaped circuit substrate 20. The elastic member 40 may be formed by coating a second face 32 of the circuit substrate 20 with a silicone-based adhesive, for example.

In this case, a first connection portion 22 and a second connection portion 24 are provided so as to each pass through at least the circuit substrate 20 and the elastic member 40 in the thickness direction of the circuit substrate 20. The electrostatic atomizer is thereby configured such that the first connection portion 22 is connected to the first heat radiation-side electrode 8A, and the second connection portion 24 is connected to the second heat radiation-side electrode 8B.

Further, in the present embodiment, the driving circuit 12 and the voltage application circuit 14 are mounted on a first face 30 side of the circuit substrate 20, and the elastic member 40 and the heat radiation-side electrodes 8 are stacked in order on the second face 32 side.

Also, the pair of thermoelectric elements 2A and 2B, a heat absorption-side electrode 4, a casing 26, and a counter electrode 28 are mounted on the pair of heat radiation-side electrodes 8A and 8B.

That is to say, the electrostatic atomizer of the present embodiment includes the pair of the first heat radiation-side electrode 8A and the second heat radiation-side electrode 8B. The first thermoelectric element 2A is provided on the first heat radiation-side electrode 8A, and the second thermoelectric element 2B is provided on the second heat radiation-side electrode 8B. The first thermoelectric element 2A and the second thermoelectric element 2B are thereby formed as a pair. Here, the heat absorption-side electrode 4 is provided so as to bridge the first heat radiation-side electrode 8A and the second heat radiation-side electrode 8B. The casing 26 is provided so as to bridge the first heat radiation-side electrode 8A and the second heat radiation-side electrode 8B such that the heat absorption-side electrode 4, the first thermoelectric element 2A, and the second thermoelectric element 2B are surrounded. Further, a counter electrode 28 is mounted on the casing 26.

Also, the electrostatic atomizer of the present embodiment as well can include, similarly to Embodiment 1, a first conductive pattern 25A, a second conductive pattern 25B, and a third conductive pattern 25C.

In the electrostatic atomizer of the present embodiment, since the elastic member 40 is interposed between the atomizing block 50 and the circuit substrate 20, even in a case where the circuit substrate 20 expands or contracts due to heat, this expansion or contraction is absorbed by the elastic member 40, and occurrence of damage or the like due to stress acting on the atomizing block 50 side can be suppressed. As a result, reliability can further be improved.

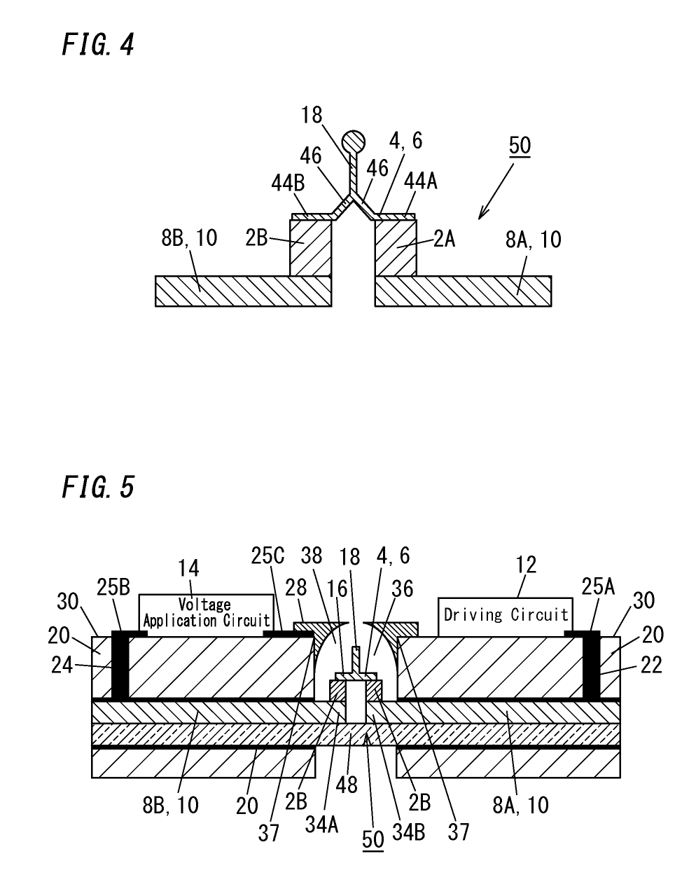

Next, an electrostatic atomizer of Embodiment 4 of the present invention will be described with reference to a main portion shown in FIG. 4. Note that constituent elements similar to those in Embodiment 1 described above are provided with the same reference numerals, and detailed description thereof will be omitted.

In the electrostatic atomizer of the present embodiment, a heat absorption-side electrode 4 that serves as a discharge electrode 6 is provided with a spring structure that is elastically deformable. Specifically, instead of a flat plate-shaped base portion 16 shown in Embodiment 1, the heat absorption-side electrode 4 includes a pair of joining portions 44A and 44B that are respectively joined to the pair of thermoelectric element 2A and 2B, and plate spring portions 46 that respectively elastically join the pair of joining portions 44A and 44B to a bar-shaped portion 18.

That is to say, the electrostatic atomizer of the present embodiment includes the heat absorption-side electrode 4 that serves as the discharge electrode 6, and the heat absorption-side electrode 4 includes a spring structure that is elastically deformable. Also, the heat absorption-side electrode 4 includes the pair of the first joining portion 44A and the second joining portion 44B, the bar-shaped portion 18, and the plate spring portions 46. The first joining portion 44A and the second joining portion 44B are joined to the first thermoelectric element 2A and the second thermoelectric element 2B, respectively. Further, the plate spring portions 46 are configured to be elastically joined to the first joining portion 44A and second joining portion 44B, respectively, with the bar-shaped portion 18 serving as a base.

In the electrostatic atomizer of the present embodiment, since the heat absorption-side electrode 4 that is provided so as to bridge the pair of thermoelectric elements 2A and 2B has a spring property itself, even in a case where the circuit substrate 20 expands or contracts due to heat, and the heat radiation-side electrodes 8 are accordingly displaced, the heat absorption-side electrode 4 is less likely to be affected by this displacement. As a result, occurrence of damage or the like due to stress acting on the thermoelectric elements 2 or the heat absorption-side electrode 4 is suppressed, and reliability is improved.

Here, the heat absorption-side electrode 4 of the present embodiment can be applied to and mounted on the electrostatic atomizers of Embodiments 1-3.

Next, an electrostatic atomizer of Embodiment 5 of the present invention will be described with reference to FIG. 5. Note that constituent elements similar to those in Embodiment 2 described above are provided with the same reference numerals, and detailed description thereof will be omitted.

In the electrostatic atomizer of the present embodiment, a porous member 48 constituted by a ceramic plate is provided so as to be in contact with a pair of heat radiation-side electrodes 8A and 8B. The porous member 48 is used as a drain passage for excess dew condensation water. Also, in the present embodiment, a counter electrode 28 constituted by a member similar to that in Embodiment 1 is mounted on an edge 37 of an opening 38 on one side of a through-hole 36.

Specifically, the through-hole 36 is formed in a center portion of a circuit substrate 20, and the pair of heat radiation-side electrodes 8A and 8B and the porous member 48 are embedded in the circuit substrate 20. Edge portions 34A and 34B of the respective heat radiation-side electrodes 8A and 8B and the center portion of the porous member 48 are exposed in the through-hole 36. The porous member 48 is stacked on the heat radiation-side electrodes 8 at a location on the side opposite to the side thereof on which a heat absorption-side electrode 4 is mounted on thermoelectric elements 2A and 2B. An outer edge portion of the porous member 48 is provided so as to be exposed from an outer peripheral face of the circuit substrate 20.

In other words, in the electrostatic atomizer of the present embodiment, the through-hole 36 is formed in the center portion of the circuit substrate 20, and the pair of the first heat radiation-side electrode 8A and the second heat radiation-side electrode 8B and the porous member 48 are embedded in the circuit substrate 20. On the center side of the through-hole 36, the first edge portion 34A of the first heat radiation-side electrode 8A and the second edge portion 34B of the second heat radiation-side electrode 8B are provided, and a center portion of the porous member 48 is provided so as to be exposed. Further, the porous member 48 is stacked on the heat radiation-side electrodes 8A and 8B at a location on the side opposite to the side thereof on which the heat absorption-side electrode 4 is mounted so as to bridge the first thermoelectric element 2A and the second thermoelectric element 2B. Furthermore, the outer edge portion (not shown) of the porous member 48 is provided so as to be exposed from the outer peripheral face (not shown) of the circuit substrate 20.

The electrostatic atomizer of the present embodiment as well can include, similarly to Embodiment 2, a first conductive pattern 25A, a second conductive pattern 25B, and a third conductive pattern 25C. The third conductive pattern 25C is configured to be connected to the counter electrode 28. Here, the third conductive pattern 25C may be formed on an inner circumferential face of the through-hole 36 and on a first face 30 of the circuit substrate 20 near the edge 37, or may be formed on the first face 30 of the circuit substrate 20 near the edge 37. However, it is preferable that the third conductive pattern 25C is formed on the first face 30 of the circuit substrate 20 near the edge 37. Note that the third conductive pattern 25C is not connected to a driving circuit 12, similarly to Embodiment 2.

When excess dew condensation water is generated in the electrostatic atomizer of the present embodiment, the excess dew condensation water is carried outside due to capillary action in the porous member 48. As a result, accumulation of water in the circuit substrate 20 is suppressed, and reliability is improved.

Here, the heat absorption-side electrode 4 of Embodiment 4 can be applied to and mounted on the electrostatic atomizer of the present embodiment.

As described above, the electrostatic atomizers of Embodiments 1 to 5 include the pair of thermoelectric elements 2A and 2B, the heat absorption-side electrode 4 that is joined to the thermoelectric elements 2A and 2B so as to serve as the discharge electrode 6 and is electrically connected to the thermoelectric elements 2A and 2B on the heat absorption sides thereof, the heat radiation-side electrodes 8A and 8B that are electrically connected to the thermoelectric elements 2A and 2B on the heat radiation sides thereof, respectively, so as to serve as the heat radiation member 10, and the circuit substrate 20 on which the driving circuit 12 for controlling energization of the pair of thermoelectric elements 2A and 2B is mounted. The heat radiation-side electrodes 8 are joined integrally to the circuit substrate 20.

Accordingly, the entire electrostatic atomizer can be downsized, and the heat radiation-side electrodes 8A and 8B that serve as the heat radiation member 10 can be provided to be large, and as a result heat radiation performance of the heat radiation member 10 and thus cooling performance of the discharge electrode 6 is improved. That is, improvement of the cooling performance of the discharge electrode 6 and downsizing of the entire device can both be realized.

Further, the electrostatic atomizers of Embodiments 1 to 5 of the present invention include the counter electrode 28 that is provided at a position opposing the heat absorption-side electrode 4, and the counter electrode 28 is joined integrally to the circuit substrate 20. Accordingly, further downsizing and cost reduction of the entire electrostatic atomizer that includes the counter electrode 28 can be realized.

Further, the electrostatic atomizers of Embodiments 1 to 5 of the present invention include the voltage application circuit 14 that applies a voltage to the counter electrode 28, and the voltage application circuit 14 is mounted integrally on the circuit substrate 20. Accordingly, further downsizing and cost reduction of the entire electrostatic atomizer that includes the voltage application circuit 14 can be realized.

Moreover, in the electrostatic atomizer of Embodiment 2 of the present invention, the counter electrode 28 is formed as a conductive pattern on the circuit substrate 20. Accordingly, further downsizing and cost reduction of the entire electrostatic atomizer that includes the counter electrode 28 can be realized.

Moreover, in the electrostatic atomizers of Embodiments 2 and 5 of the present invention, the circuit substrate 20 includes the through-hole 36 that passes through in the thickness direction thereof, and the thermoelectric elements 2 are arranged in the through-hole 36. Since the through-hole 36 serves as a drain passage, accumulation of excess dew condensation water in the circuit substrate 20 is suppressed.

Moreover, in the electrostatic atomizer of Embodiment 3 of the present invention, the elastic member 40 is interposed between the heat radiation-side electrodes 8 and the circuit substrate 20. Accordingly, since thermal expansion and contraction of the circuit substrate 20 can be absorbed by the elastic member 40, occurrence of damage to the thermoelectric elements 2A and 2B or the like is suppressed.

Moreover, in the electrostatic atomizer of Embodiment 4 of the present invention, the heat absorption-side electrode 4 includes the elastically deformable spring structure. Accordingly, the heat absorption-side electrode 4 is less likely to be affected by thermal expansion and contraction of the circuit substrate 20, and as a result occurrence of damage to the thermoelectric elements 2A and 2B or the like is suppressed.

Moreover, in the electrostatic atomizer of Embodiment 5 of the present invention, the porous member 48 serving as a drain passage for excess dew condensation water is arranged on the heat radiation-side electrodes 8. Since the excess dew condensation water is drained through the porous member 48, accumulation of the excess dew condensation water in the circuit substrate 20 is suppressed.

Although the present invention has been described above with reference to the attached diagrams, the present invention is not limited to the aforementioned embodiments, and the design in the examples can be modified as appropriate and the configurations of the examples can be combined and applied as appropriate, as long as it is in the intended scope of the present invention.

1. An electrostatic atomizer comprising:
a pair of thermoelectric elements;
a heat absorption-side electrode that is joined to the thermoelectric elements so as to serve as a discharge electrode, and that electrically connects the pair of thermoelectric elements on heat absorption sides thereof;
heat radiation-side electrodes that are electrically connected to the respective thermoelectric elements on heat radiation sides thereof so as to serve as a heat radiation member; and
a circuit substrate on which a driving circuit configured to control energization of the pair of thermoelectric elements is mounted,
wherein the heat radiation-side electrodes are joined to the circuit substrate so as to be integrated therewith.

2. The electrostatic atomizer according to claim 1, comprising:
a counter electrode provided at a position opposing the heat absorption-side electrode,
wherein the counter electrode is joined to the circuit substrate so as to be integrated therewith.

3. The electrostatic atomizer according to claim 2, comprising:
a voltage application circuit configured to apply a voltage to the counter electrode,
wherein the voltage application circuit is mounted on the circuit substrate so as to be integrated therewith.

4. The electrostatic atomizer according to claim 2,
wherein the counter electrode is formed as a conductive pattern on the circuit substrate.

5. The electrostatic atomizer according to claim 1,
wherein the circuit substrate includes a through-hole that passes therethrough in the thickness direction, and the thermoelectric elements are arranged in the through-hole.

6. The electrostatic atomizer according to claim 1,
wherein an elastic member is interposed between the heat radiation-side electrodes and the circuit substrate.

7. The electrostatic atomizer according to claim 1,
wherein the heat absorption-side electrode includes an elastically deformable spring structure.

8. The electrostatic atomizer according to claim 1,
wherein a porous member serving as a drain passage for excess dew condensation water is arranged on the heat radiation-side electrodes.

9. The electrostatic atomizer according to claim 2,
wherein the counter electrode and a conductive pattern are connected.
